(19) United States
(12) Patent Application Publication
(10) Pub. No.: US 2024/0336178 A1
(43) Pub. Date: Oct. 10, 2024

(54) ADJUSTABLE/PERSONALISED SEAT ARRANGEMENT AND SYSTEM

(71) Applicant: Barend Jacobus STANDER, East London (ZA)

(72) Inventor: Barend Jacobus STANDER, East London (ZA)

(21) Appl. No.: 18/695,256

(22) PCT Filed: Sep. 28, 2022
(86) PCT No.: PCT/IB2022/059233

§ 371 Date: Mar. 25, 2024

(30) Foreign Application Priority Data
Sep. 28, 2021 (ZA) 2021/07247

(51) Int. Cl. B60N 2/64; B60N 2/00; B60N 2/02; B60N 2/66

(52) U.S. Cl. CPC B60N 2/643; B60N 2/0028; B60N 2/0268; B60N 2/0272; B60N 2/665

(57) ABSTRACT

The invention relates to an adjustable/personalised seat arrangement which includes (i) a plurality of support members which supports different portions of a person's back. (ii) at least one adjustment arrangement which selectively adjusts each support member, and (iii) a control module. The control module receives/retrieves information which corresponds to a particular seating position for a specific person. The received/retrieved information also corresponds to spinal length, spinal curvatures and/or individual vertebral angles of the person's spine. The control module utilises the received/retrieved information and the adjustment arrangement in order to selectively adjust each support member into a position which corresponds with and supports the specific person's back. The invention also relates to a method of creating a personalised seat/sitting profile for a particular person. The method includes taking measurements of the particular person's spine and generating a seat/sitting profile for the person by utilising the measurements.

### BACKGROUND OF THE INVENTION

THIS invention relates to an adjustable seat arrangement and to a system for, and method of, personalising a seat.

At present, there are some types of seats, such as car seats, which can be adjusted manually by a person sitting on the seat. The seat would, for example, have a few basic control buttons (e.g. to move the seat forward or back, etc.) which the person can use in order to personalise it for greater comfort.

These seats are however purely adjusted based on the specific person's input and does not actually take the person's actual, unique body features/parameters/characteristics into account. As a result, even though the person might believe that he/she is sitting in a relatively comfortable position, he/she might not be in the best seated position, medically speaking, based on his/her specific, unique body features/parameters/characteristics.

U.S. Pat. No. 10,328,823 describes a seat assembly and a method for adjusting the seat assembly in accordance with anthropometric data, as well as other data of a user. The seat assembly is able to adjust the thoracic, back bolster, lumbar and cushion bolster areas based on professionally sourced anthropometric data. However, the anthropometric data is obtained through a kind of crowd-sourcing exercise where anthropometric data is collected from numerous people. The data is therefore not user-specific.

WO 2012/048100 discloses a system wherein occupant anthropometric data is used to adjust the seat of a vehicle to suit them. The anthropometric data may be manually measured and inputted or the data may be determined using a body dimension calculation algorithm. The document however does not mention how the anthropometric data is actually used, and which specific anthropometric data is used, in order to adjust a seat.

The Inventor wishes to provide a solution which allows a seat to be adjusted automatically, in a unique way, by using certain key measurement data of a specific person.

### SUMMARY OF THE INVENTION

In accordance with a first aspect of the invention there is provided an adjustable/personalised it arrangement, wherein the seat arrangement includes:
a plurality of support members which, in use, supports different portions of a person's back, when the person is seated on the seat arrangement;
at least one adjustment arrangement which is configured to selectively adjust each support member, relative to the other support member(s); and
a control module which is configured to
   receive/retrieve information which can be translated to, or corresponds to, a particular seating position for a specific person, wherein the received/retrieved information also relates to, or corresponds to:
      a spinal length of the specific person's spine,
      one or more spinal curvatures of the spine, and/or
      individual vertebral angles of the spine, and
   utilise the received/retrieved information and the adjustment arrangement in order to selectively adjust each support member into a position which corresponds with and supports the specific person's back, when the person is seated on the seat arrangement.

The adjustment arrangement may be, or include, an actuator arrangement. The adjustment arrangement may be, or include, a bladder arrangement.

The one or more spinal curvatures of the spine may include a lumbar curvature of the spine, a cervical curvature of the spine and/or a thoracic curvature of the spine.

The received/retrieved information may also include information which relates to a pelvic hip angle of the specific person, an arm length and/or leg length.

The received/retrieved information may therefore include information which relate to any one or more of the following:
a spinal length of the spine,
a lumbar curvature of the spine,
a cervical curvature of the spine
a thoracic curvature of the spine,
individual vertebral angles of the spine,
a pelvic hip angle of the specific person,
an arm length of the specific person,
a leg length of the specific person,
a knee flexion angle(s), and
an elbow flexion angle(s).

The seat arrangement may include a wireless communication module which is configured to receive the information via wireless communication, which is then utilised by the control module. The information may be received wirelessly from a mobile communication device of the person (e.g. a phone or wireless key).

The seat arrangement may include a reader/scanner which is configured to retrieve/capture the information from a key, tag (e.g. an RFID tag) or visual code (e.g. a barcode, such as a QR code).

At least a portion of the plurality of support members may be spaced along a length of the spine of the person, when the person is seated on the seating arrangement, in order to form a back support. The back support may extend operatively upwardly from a sitting portion of the seat arrangement. At least some of the support members may be elongated.

The plurality of support members may include:
one or more support members which, in use, supports a lumbar region of a person's back/spine;
one or more support members which, in use, supports a thoracic region of a person's back/spine;
one or more support members which, in use, supports a sacral region of a person's back/spine;
one or more support members which, in use, supports a cervical region of a person's neck/spine; and/or
   one or more support members which, in use, supports a person's buttocks region, thereby providing a seat support.

One or more, preferably each, of the support members may be elongate and extend transverse to an upward direction in which a person's spine extends, when seated on the seat arrangement. More specifically, one or more, preferably each, of the support members may extend in a lateral direction, when the seat arrangement is viewed from the front. The support members may therefore extend from a one side of the seat arrangement (e.g. a left side) towards an opposite side (e.g. the right side).

One or more, preferably each, of the support members may include, or be in the form of, a rib/support formation. Each rib/support formation may extend transversely across a spinal direction of a person, when seated on the seat arrangement.

The adjustment arrangement may include an adjustment mechanism for each rib/support formation in order to adjust the rib/support formation. The adjustment mechanism may include a motor/drive unit which is configured to adjust the rib/support formation. The adjustment mechanism may be configured to move its corresponding rib/support formation operatively forwardly and/or rearwardly, based on the received/retrieved information, relative to the other rib/support formation(s), in order to support the person's back/spine.

The adjustment mechanism may be an actuator.

One or more, preferably each, of the support members may include, or be in the form of, a bladder/bladder arrangement. The bladder/bladder arrangement may be inflatable. The adjustment arrangement may be configured to inflate or deflate the bladder/bladder arrangement.

The seat arrangement may include an adjustment arrangement for each bladder/bladder arrangement. The control module may be operatively connected to each adjustment arrangement and may be configured to use each adjustment arrangement in order to inflate or deflate its associated bladder/bladder arrangement, based on the received/retrieved information, in order to support the person's back/spine.

The seat arrangement may therefore include a plurality of bladders (e.g. 19-24) which can be adjusted (e.g. inflated or deflated) using an inflatable/inflation system, wherein the adjustment is based on the received/retrieved information, in order to support the person's back/spine.

In accordance with a second aspect of the invention there is provided a system for adjusting a seat for a particular person, wherein the system includes:
a spinal measuring system/arrangement/tool/device (or spinal assessment system/arrangement/tool/device) which is configured to measure one or more of the following:
   a spinal length of the specific person's spine,
   one or more spinal curvatures of the spine, and/or
   individual vertebral angles of the spine; and
a seat arrangement in accordance with the first aspect of the invention,
wherein the control module is configured to utilise measurement information which relates to, or corresponds with, the measurement(s) taken by the measurement system/arrangement/tool/device in order to adjust each support member into a position which corresponds with and supports the specific person's back, when the person is seated on the seat arrangement.

The one or more spinal curvatures of the spine may include a lumbar curvature of the spine, a cervical curvature of the spine and/or a thoracic curvature of the spine.

The information may also relate to a pelvic hip angle of the specific person, an arm length and/or leg length.

The information may therefore relate to any one or more of the following:
a spinal length of the spine,
a lumbar curvature of the spine,
a cervical curvature of the spine
a thoracic curvature of the spine,
individual vertebral angles of the spine,
a pelvic hip angle of the specific person,
an arm length of the specific person,
a leg length of the specific person,
a knee flexion angle(s), and
an elbow flexion angle(s).

In accordance with a third aspect of the invention there is provided a method of providing support for a particular person, wherein the method includes:
receiving/retrieving/obtaining information which can be translated to, or corresponds to, a particular seating position for a specific person, and wherein the information further also relates to, or corresponds to:
   a spinal length of the specific person's spine,
   one or more spinal curvatures of the spine, and/or
   individual vertebral angles of the spine; and
providing/producing a personalised back support by utilising the received/retrieved/obtained information, which provides support for the specific person's back/spine, when the person is seated on a seat.

The step of providing/producing a personalised back support may more specifically include adjusting a back support of a seat based on the received/retrieved/obtained information, in order to support the specific person's back/spine, when the person is seated on the seat.

The step of adjusting the back support may more specifically include automatically adjusting, by using a control arrangement/module, the back support of the seat based on the received/retrieved/obtained information, in order to support the specific person's back/spine, when the person is seated on the seat.

The step of providing/producing the personalised back support may include manufacturing a personalised back support pad/pillow/cutout by utilising the received/retrieved/obtained information. The back support may be made from foam or may be foam-based. The back support may therefore be a foam-based cut-out.

The control module may be the control module of the seat arrangement in accordance with the first aspect of the invention.

The method may include creating a sitting profile for the user which includes the said received/retrieved/obtained information. The step of creating the sitting profile may include using a spinal measuring system/arrangement/tool/device to take measurements of the person's spine, and using the measurements as the information to provide/produce the personalised back support. The spinal measuring system/arrangement/tool/device may be a system/arrangement/tool/device which is configured to measure/assess curvatures of a spine/vertebral column of a person.

The spinal measuring system/arrangement/tool/device may be guided on the body of the user, along his/her spine, in order to take the measurements. The spinal measuring system/arrangement/tool/device may be guided on the body, but over clothing worn by the user. Alternatively, the spinal measuring system/arrangement/tool/device may be guided on the body, directly on the skin of the user. The spinal measuring system/arrangement/tool/device may include one or more, preferably two, rollers which is/are configured to allow contour tracking, more specifically spinous contour tracking. The spinal measuring system/arrangement/tool/device may include at least one sensor, preferably three sensors (e.g. one for each place of a three-dimensional system of Cartesian axes, i.e. x, y and z). The spinal measuring system/arrangement/tool/device may be configured to calculate distance travelled over change in space and may include an inclinometer, accelerometer and distance wheel. The spinal measuring system/arrangement/tool/device may be a so-called Spinal Mouse™ developed by IDAG AG (https://spinalmouse.ro/en).

In a slight alternative embodiment, the spinal measuring system/arrangement/tool/device may be configured to take measurements of the person's spine without any physical contact with the person (i.e. it may be a contactless system/arrangement/tool/device which, for example, uses laser-based technology).

The method may include guiding the tool/device along a spine of the person, in order to take the measurements.

In accordance with a fourth aspect of the invention there is provided a method of creating a personalised seat/sitting profile for a particular person, wherein the method includes:
taking measurements of the particular person's spine; and
generating, by using a processor, a seat/sitting profile for the person by utilising the measurements.

The sitting profile may include details of a specific seating configuration for the particular person.

The measuring step may include using a spinal measuring tool/device/system to take measurements of the person's spine. These measurements may be used as the information to adjust the back support. The tool/device may be a tool/device which is configured to measure/assess curvatures of a spine/vertebral column of a person. The measuring tool/device maybe guided on the skin of the user, along his/her spine, in order to take the measurements. The tool/device may include one or more rollers (preferably two or more) which are configured to allow contour tracking, more specifically spinous contour tracking. The tool/device may include at least one sensor, preferably three sensors (e.g. one for each plane of a three-dimensional system of Cartesian axes, i.e. x, y and z). The tool/device may be configured to calculate distance travelled over change in space and may include an inclinometer, accelerometer and/or distance wheel. The tool/device may be a so-called Spinal Mouse™.

The measuring step may include guiding the tool/device/system along a spine of the person, in order to take the measurements.

The measurements may relate to:
a spinal length of the specific person's spine,
one or more spinal curvatures of the spine,
individual vertebral angles of the spine,
an arm length of the specific person, and/or
a leg length of the specific person.

More specifically, the measurements may relate to one or more of the following:
a spinal length of the spine,
a lumbar curvature of the spine,
a thoracic curvature of the spine,
a cervical curvature of the spine,
individual vertebral angles of the spine,
a pelvic hip angle of the specific person,
an arm length of the specific person,
a leg length of the specific person,
a knee flexion angle(s), and
an elbow flexion angle(s).

In accordance with a fifth aspect of the invention there is provided a method of personalising a seat for a particular person, wherein the method includes:
implementing the method in accordance with the fourth aspect of the invention; and
adapting a seating arrangement for the particular person, by using a control arrangement which utilises the sitting/seat profile in order to perform the adaptation.

In accordance with a sixth aspect of the invention there is provided a method of producing a personalised back support for a particular person, wherein the method includes:
implementing the method in accordance with the fourth aspect of the invention in order to create a personalised seat/sitting profile for the person; and
manufacturing a back support by utilising the personalised seat/sitting profile.

In accordance with a seventh aspect of the invention there is provided a method of producing a personalised back support for a particular person, wherein the method includes:
receiving/retrieving a personalised seat/sitting profile for the person; and
manufacturing a back support by utilising the personalised seat/sitting profile.

The personalised seat/sitting profile may have been obtained by implementing the method in accordance with the fourth aspect of the invention.

### BRIEF DESCRIPTION OF THE DRAWINGS

The invention will now be described, by way of example, with reference to the accompanying drawings. In the drawings:

FIG. 1 shows a schematic illustration of the different spinal regions of a human;

FIG. 2 shows a schematic illustration of a spinal measuring tool for taking measurements of a person's spine;

FIG. 3 shows a side view of a seat arrangement in accordance with the invention;

FIG. 4 shows a top view of the seat arrangement shown in FIG. 3;

FIG. 5 shows a side view of another example of a seat arrangement in accordance with the invention;

FIG. 6 shows a top view of the seat arrangement shown in FIG. 5;

FIG. 7 shows a three-dimensional view of a further example of a seat arrangement in accordance with the invention;

FIG. 8 shows another three-dimensional view of the seat arrangement shown in FIG. 7;

FIG. 9 shows a side view of yet a further example of a seat arrangement in accordance with the invention, without upholstering;

FIG. 10 shows a side view of the seat arrangement shown in FIG. 9, wherein support members thereof are in a different configuration/position;

FIG. 11 shows a three-dimensional view of another example of a seat arrangement in accordance with the invention, with upholstering, and which also illustrates support formations (e.g. bladders) which are secured to respective ends of support members which form part of the seat arrangement;

FIG. 12 shows another three-dimensional view of the seat arrangement shown in FIG. 11, with a control panel included on a side of the seat arrangement;

FIG. 13 shows partial side view of the seat arrangement shown in FIG. 12;

FIG. 14 shows a schematic side view of a seat arrangement in accordance with the invention, as well as a spinal curve of a person seated on, and being supported by, the seat arrangement;

FIG. 15 shows a schematic illustration of total angle of the Thoracic spine (or midback area) of a person;

FIG. 16 shows a table which sets out various measurements taken by a spinal measuring tool (as shown in FIG. 12);

FIG. 17 shows a table which sets out research values depicting average curvatures and ranges of the thoracic spine;

FIG. 18 shows a schematic layout of the system in accordance with the invention;

FIG. 19 shows a flow diagram of a system flow of the system in accordance with the invention;

FIG. 20 shows a graphical illustration of a triangulation used to calculate a leg distance;

FIG. 21 shows a further example of a seat arrangement in accordance with the invention, without upholstering;

FIG. 22 shows a three-dimensional view of a back support member/cushion; and

FIG. 23 shows a three-dimensional view of the back support member/cushion shown in FIG. 22, when secured to a backrest of a chair.

### DESCRIPTION OF PREFERRED EMBODIMENTS

The present invention focusses on creating a unique sitting/seat profile that conforms to the uniqueness of each human body. As all parameters of a human body are unique, this invention allows a setup that is specifically tailored to the exact data/measurements of each person/user. The invention utilises a spinal measuring tool/device (e.g. the Spinal Mouse™ developed by IDIAG AG) to take various spinal measurements, as well as leg length and arm length measurements. The spinal measuring tool/device typically calculates distance travelled over change in space. It is comprised of an inclinometer, accelerometer and distance wheel. The tool allows for the measurements of the spine and its curvatures and lengths. The tool can also be used to measure lengths of extremities, such as arm length and leg length. The tool can therefore be used to measure a person's parameters, which includes the spine with individual vertebral angles, as well as total length of spine and extremities (e.g. arm length and leg length). Thus, a total profile can be made using this tool, which is already well-known in the market.

The measurements can typically include the following:
a spinal length of the spine,
a lumbar curvature of the spine,
a cervical curvature of the spine,
a thoracic curvature of the spine,
individual vertebral angles of the spine,
a pelvic hip angle of the specific person,
an arm length of the specific person,
a leg length of the specific person
a knee flexion angle(s) of the specific person, and
an elbow flexion angle(s) of the specific person.

The spinal measuring tool forms part of a system in accordance with the invention.

The system, in accordance with the invention, also includes a software program (e.g. a mobile app installed on a smart device of a medical practitioner (or other person taking measurements) or as program installed on a computer), which receives the data from the spinal measuring tool/device (e.g. via Bluetooth or another type of wireless/wired communication) after all measurements have been made. The data can be received in various manners as will be discussed below. The software program is configured to translate the data to movable parts of a user's chair (e.g. a car seat), more specifically a chair arrangement in accordance with the invention, to move or orientate all support areas into the correct seating positions, as well as distances from the steering wheel and pedals also including seat height and pelvic tilt for optimal hip and knee angles, as required by the uniqueness of the user. This setup will still conform to research parameters of correct positions within calculated ranges of normal, e.g. a lumbar curvature should be between of 20-40 degrees. Should a client be too far out of “normal” ranges, the program is accordingly configured to, over time, slowly increase the curvature to eventually have the client sitting in a more safe and ergonomic position. In this regard, it should be noted that the software program can also be installed as a mobile app on a user's smart device (e.g. smart phone). The mobile app installed on the user's phone will then adjust a specific curvature over time, if it falls outside a safe/normal range.

All this data will be saved in a code format which corresponds to the exact sitting/seat position, i.e. a unique code/sitting profile which corresponds to the exact setup. It may thus be that another user in the world has the exact measurements and thus will have the exact same code/sitting profile.

The mobile app is configured to communicate with the seat arrangement via wireless (e.g. Bluetooth) communication. Thus, a user can connect remotely (by using his phone on which the mobile app is stored) to different chairs with this technology, in order to allow for the chair to be positioned according to the user's unique parameters/sitting profile. The app can also send the data to a central server for storage or to cloud storage. The table below shows an example of the type of information which forms part of a user's stored data:

| Gender: Male | Age: 30 | |
|---|---|---|
| Height (e.g. 1.8 m tall) | Spinal length (e.g. 64 cm) | |
| Arm length (e.g. 80 cm) | Leg length (e.g. 120 cm) | |
| Lumbar curve (e.g. 35 degrees) | Thoracic curve (e.g. 64 degrees) | |
| Individual measurements: | | |
| Cervical | −18.50 | degrees |
| Thoracic | +45.0 | degrees |
| Lumbar | −30.0 | degrees |
| Hip angle | 135 | degrees |
| Elbow angle | 20 | degrees |
| Knee angle | 20 | degrees |

| | |
|---|---|
| Unique code/Sitting profile | V10.R56.Te.P82.10.50 as example |

The present invention also provides an online web browser/website, which forms part of the system, and which allows medical practitioners (or other companies) to access the said data of the user (e.g. which is stored at the central server or in cloud storage), in order to determine averages (as data over years stream in regarding average, percentage of population in different age categories and their values, etc.).

The present invention therefore effectively creates a standardised system that can be used in any chair with the same technology as the present invention (i.e. the “chair arrangement” in accordance with the invention). The program also allows a user to adapt his/her sitting profile (based on personal comfort/preferences, but staying in a safe/normal range), which will result in a new code/sitting profile, which is accordingly saved on the mobile app installed on the phone of the user (as well as on a central database and possibly a cloud server). Once the user's specific setup has been made, a specific code/sitting profile will be assigned to the user and stored on the mobile app installed on the phone of the user, as well as at a central database. The sitting profile can then also be placed/transferred (e.g. via a transponder) into a car key, for example, which will, as the car unlocks, move a seat arrangement of the car (i.e. a car seat which incorporates the technology of the present invention) into the correct position, prior to sitting. The same can be done for aircraft seats through a key card with a barcoded stamp (which incorporates the sitting profile) which, when swiped/read by a card reader secured to (or which forms part of) a pilot's chair (which incorporates the technology of the present invention), will move the pilot chair into the correct position. In this example, the card reader would be connected to a control module of the pilot's chair.

The seat arrangement of the present invention utilises an adjustment arrangement/system in order to adjust a seat for a particular person. The system comprises multiple bladders or ribs or other support members (or other supports) (e.g. 6-24) which can be moved/displaced using a motorised system or an inflatable system to conform to the exact changes required to meet the user's specific measurements. The seat arrangement can also be configured to move/displace the seat forwards, backwards, upright or down in order to be at the exact distances to control panels/structures (e.g. a steering wheel and pedals of a car) as calculated through a mathematical equation of angles (i.e. by taking into account the arm length, leg length and spinal length of the user). For example:

$$\\ C = \sqrt{{A}^{{}_{} 2} + {B}^{{}_{} 2} - 2 ( A ) ( B ) cos θ}$$

wherein
   “C” refers to a calculated leg distance
   “A” refers to a length of a person's leg above the knee (i.e. upper leg length)
   “B” refers to a length of the person's leg below the knee (i.e. lower leg length)
   “θ” refers to a recommended amount of bend in the person's knee (preferably about) 20°.

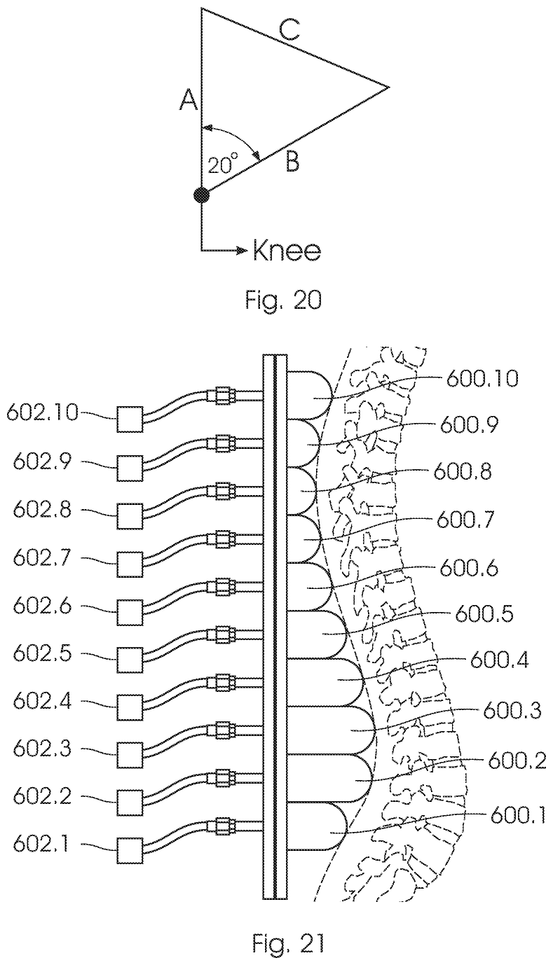

Reference is in this regard specifically made to FIG. 20.

The same algorithm can also be used to calculate arm distance.

The ribs may also be moved/displaced using manually-operated actuators.

It should be clear that the seat arrangement forms part of the system in accordance with the invention.

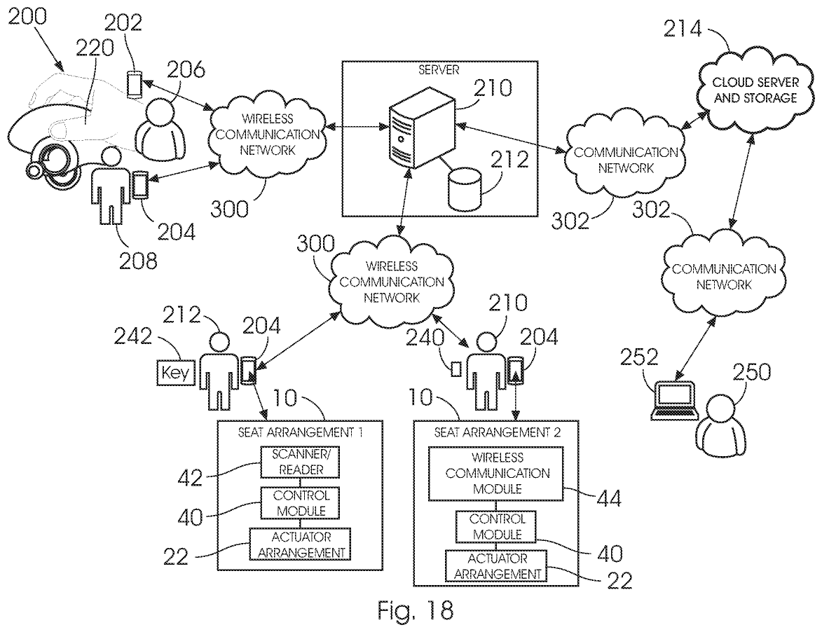

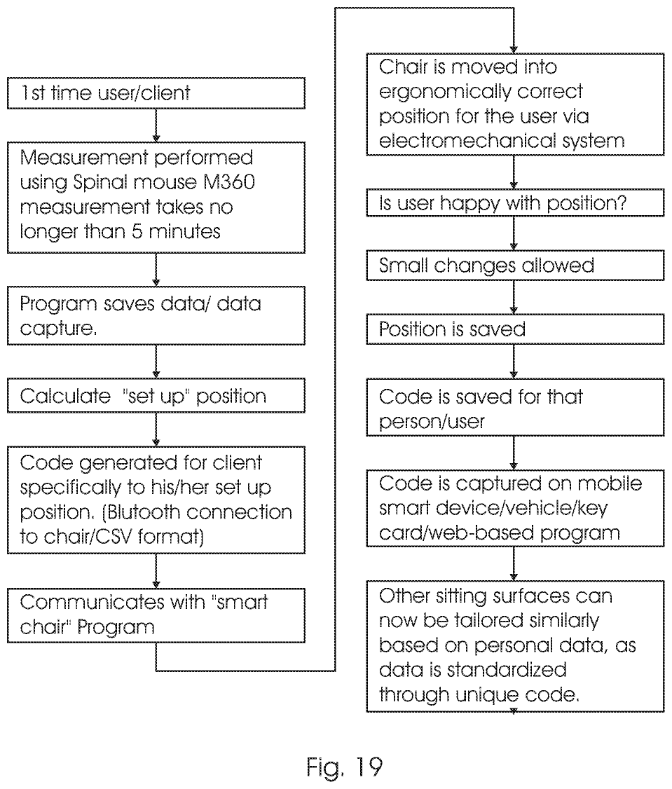

In the drawings, reference numeral 10 refers generally to an adjustable seat arrangement in accordance with the invention. By referring specifically to FIG. 18, it should be noted that the seat arrangement 10 forms part of a system 200 in accordance with the invention. The system 200 also includes a mobile app which is installed on smart devices 202, 204 of both medical practitioners (or other measurement takers) 206 and users 208. The system 200 also includes a spinal measuring tool 220 (e.g. Spinal mouse M360) used by the medical practitioner 206 to take the spinal measurements (as well as extremity measurements, e.g. leg length and arm length). The tool 220 then sends the information to the mobile app installed on the medical practitioner's phone 202 via wired/wireless communication (e.g. Bluetooth). The mobile app is configured to communicate with a central server 210 via a wireless telecommunication network 300, in order to send sitting profile information thereto. The server 210 has a database 212 on which the sitting profile information is stored. The server 210 is also configured to transmit sitting profile information to a cloud storage server 214 via a communication network 302, in order to store the information in the cloud.

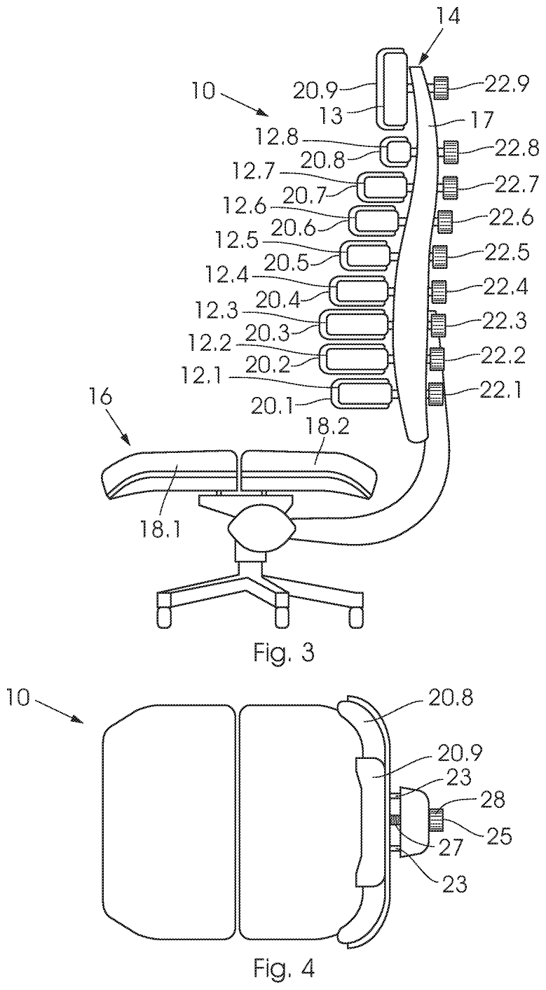

In the example shown in FIGS. 3 and 4, the seat arrangement 10 includes a plurality/series of support members 12.1-12.8 (collectively hereinafter referred to as the “support members 12”). The support members 12 are spaced along a back support 14 of the seat arrangement, and are secured to a back-support structure 17, in order to thereby support a person's back/spine, when seated thereon (i.e. essentially forming a backrest). The support members 12 are each elongate and extend transversely across the back support 14 from one side (e.g. left side) to the other (e.g. right side of the seat). The seat arrangement 10 also includes a head support 13.

The seat arrangement 10 includes a seat/seat portion 16 on which a person sits, when seated on the seat arrangement 10. The seat portion 16 includes two support members 18.1, 18.2 (collectively hereinafter referred to as the “support members 18”).

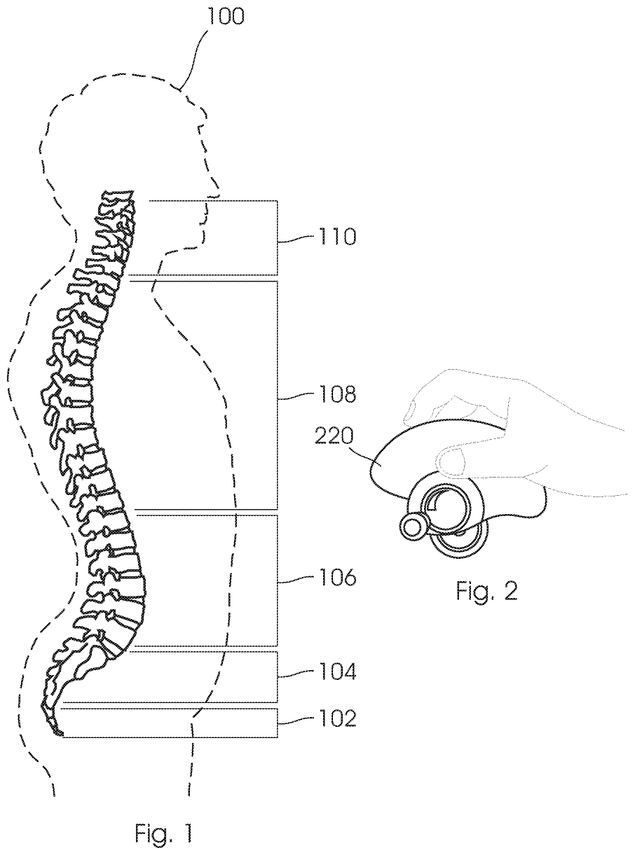

When a person 100 is seated on the seat portion 16, the support members 12, 18 typically support different portions of the person's buttocks, spine 101 and head. For example:
the support members 18 support a buttocks region of the person;
support member 12.1 supports a coccyx region 102 and sacral region 104 region of the person's spine 101 (see also FIG. 1);
support members 12.2 and 12.3 support a lumbar region 106 of the person's spine 101;
support members 12.4-12.6 support a thoracic region 108 of the person's spine 101; and
support members 12.7 and 12.8 support a cervical region 110 of the person's spine 101.

In one example (see FIGS. 3 and 4), the support members 12 may each be in the form of a rib formation/elongate support 20.1-20.8 (hereinafter collectively referred to as the “rib formations 20”) which extends transversely across the back support 14 from one side to the other. The seat arrangement 10 includes an adjustment arrangement for moving/displacing each rib formation 20 individually relative to the other rib formations 20. More specifically, the adjustment arrangement includes a set of adjustment mechanisms 22.1-22.8 which are each operatively connected to one of the rib formations 20 in order to move/displace each rib formation 20 individually relative to the other rib formations 20.

The adjustment mechanisms 22.1-22.8, in the example shown in FIGS. 3 and 4, are in the form of actuators 22.1-22.8 (collectively hereinafter referred to as the “actuators 22”). The actuators 22 are typically mounted to the back support structure 17 (which in this example is in the form of a curved beam, e.g. made from metal) and are each configured to move its corresponding rib formation 20 forwardly or rearwardly, relative to the other rib formations 20. It should also be noted that an actuator 22.9 is also mounted to the head support 14, in order to move the head support 14 forwardly or rearwardly, relative to the other rib formations 20.

Each actuator 22 has two sliding bars/rods 23 and a turn-screw mechanism 25. The turn-screw mechanism 25 has a screw-threaded bolt 27 which extends through a hole in the back support structure 17 and an end of the bolt 27 is screwed into a complementary, screw-threaded hole provided in the corresponding rib formation 20. A turning knob 28 is provided at an opposite end of the bolt 27, in order to allow the bolt 27 to be turned manually. The bars 23 are located on either side of the bolt 27 and are secured to, and project forwardly from, the back support structure 17. The bars 23 extend into corresponding holes provided the rib formation 20 in such a manner that the rib formation can slide along the length of the bars 23 (i.e. forwardly and rearwardly), whilst also providing stability for the rib formation 20.

By turning the knob 28 clockwise/anticlockwise, the bolt 27 would engage with the screw-threaded formation of the rib formation 20 in order to either move the rib formation 20 rearwardly (e.g. as the bolt 27 screws into the rib formation 20, it effectively pulls the rib formation 20 rearwardly) or forwardly (e.g. as the bolt 27 screws out of the rib formation 20, it effectively pushes the rib formation 20 forwardly). During the turning of the knob 28, the bars 23 effectively prevent the rib formation 20 from rotating with the bolt 27 and guide the rib formation 20 rearwardly or forwardly (depending on the direction in which the knob 28 is turned).

It should be noted that the support members 18.1, 18.2 also include corresponding adjustment arrangements (e.g. actuators/) for moving/displacing the support members 18.1, 18.2 relative to the support members 12 (e.g. anteriorly, posteriorly, superiorly and inferiorly). In this regard it should be noted that leg length is determined by a person's upper leg (femur) and lower leg (tibia). When the length of a person's tibia is known, then it is possible to determine how high the seat must be so that your feet are on the ground (e.g. the support members 18.1, 18.2 can be displaced upwardly). It should however be borne in mind that there is also about a 2 cm gap just behind your knee. If the tilt is too high, it will lift your feet in the air, if too low then your thighs are not supported enough. The support member 18.2 is used in combination with a person's pelvis angle to reach a +−120 degree pelvis hip angle. Tilted too high then it will cause pelvis flexion, decreasing the angle, for example, to 100 degrees of pelvis hip angle or vice versa.

One application of the chair arrangement 10 shown in FIGS. 3 and 4 may be an office chair. For example, once measurements are taken using the tool 220, the values of how the spine curves at each point, as well as in totality (including the location of each spinal region), are known. The rib formations 20 can then be adjusted forwardly or backwardly (using the knobs 28) until it meets an exact curvature of the spine throughout all the levels of the spine (i.e. the entire length of the spine). A person may, for example, get scanned/measured with the tool 220 and thereafter, the chair arrangement 10 is set up in order to conform to the measurements.

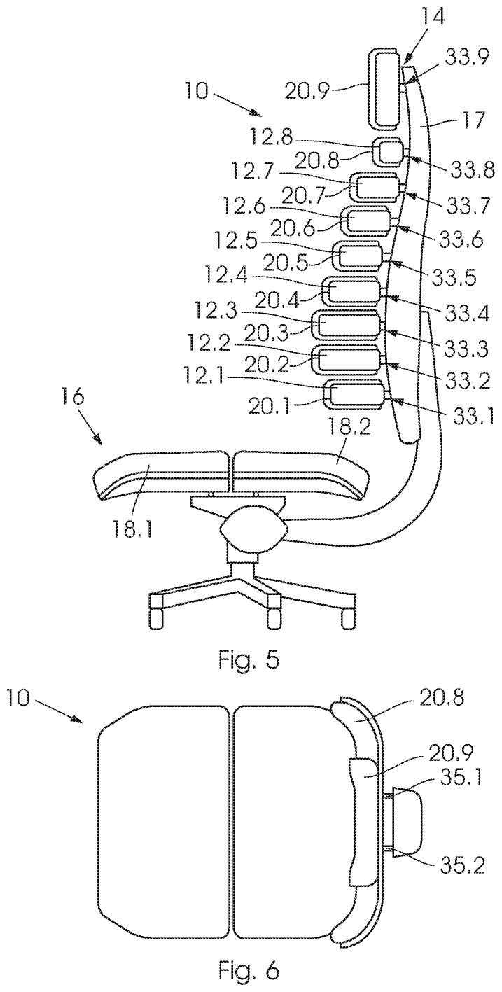

In the example shown in FIGS. 5 and 6, the manual adjustment of the rib formations 20 is eliminated by replacing the turn-screw mechanism 25 with a drive/actuator mechanism 33.1-33.9 (hereinafter collectively referred to as “33”) which can move the rib formation 20 rearwardly or forwardly (e.g. by using a drive/motorised unit or actuator). Each drive/actuator mechanism 33 is configured to receive adjustment instructions from a control module 40 (described further below), in order to adjust the rib formation 20 rearwardly or forwardly. For example the drive/actuator mechanism 33 may include two bolts 35.1, 35.2 which project forwardly from a drive unit of the drive mechanism (e.g. located inside the back support structure 17). A front end of each bolt 35.1, 35.2 is secured to the rib formation 20 such that if the bolts 35.1, 35.2 are extended further out (i.e. by operating the drive/actuator mechanism 33), then the rib formation 20 is moved forwardly. Similarly, if the bolts 35.1, 35.2 are retracted (i.e. by operating the drive/actuator mechanism 33), then the rib formation 20 is moved rearwardly.

One application of the chair arrangement 10 shown in FIGS. 5 and 6 may be a wheelchair.

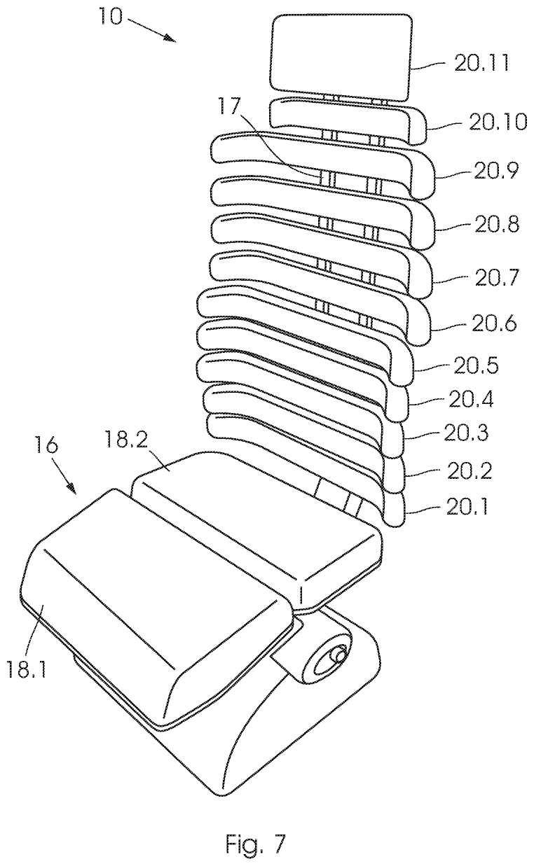

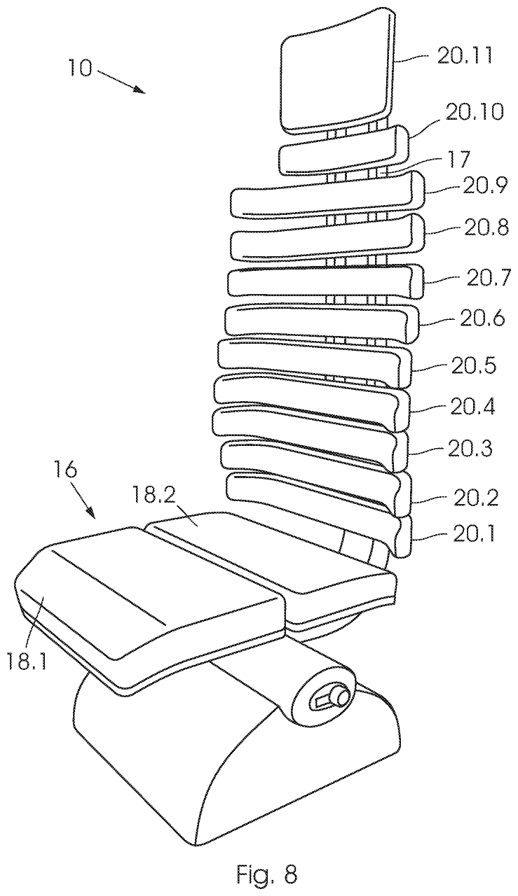

FIGS. 7 and 8 show a similar embodiment to the one illustrated in FIGS. 3 and 4, except that the total number of rib formations are 10 (not 8).

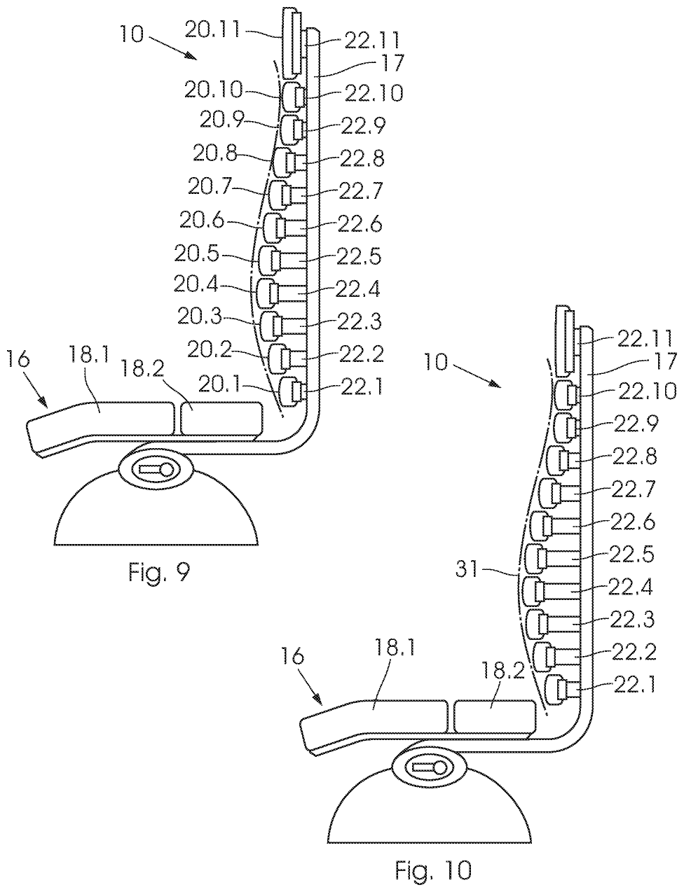

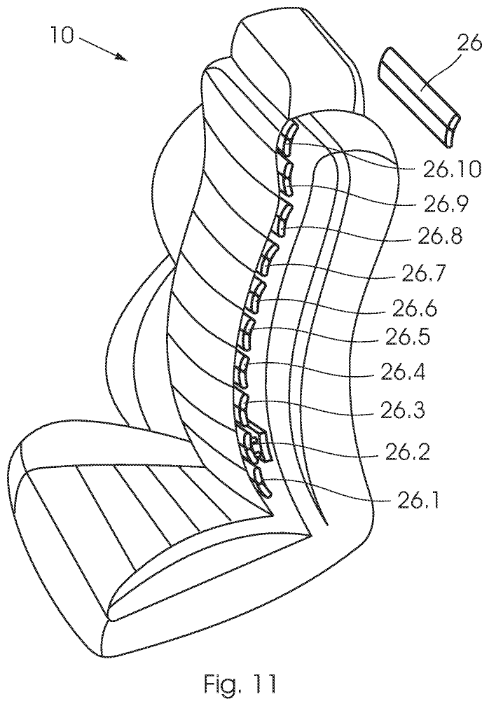

FIGS. 9 and 10 illustrate another variation of the seat arrangement 10 (e.g. for office chairs, wheel chairs or cockpit chairs) where the support members 12 can be ribs or support cushions 20 (20.1-20.11) which extend from a one side of the seat arrangement (e.g. a left side) across to an opposite side (e.g. the right side). Each rib/support cushion 20 is connected to the back support structure 17 via an actuator 22 (22.1-22.11). The actuator 22 is again configured to displace the rib/support cushion 20 forwardly or rearwardly relative to the other rib/support cushions 20. Reference is in this regard specifically made to FIG. 9 in which the rib/support cushion 20.1 is more retracted (i.e. spaced rearwardly), when compared to FIG. 10. In this example, the ribs/support cushions 20 may be located underneath an upholstery 31 of the seat arrangement 100.

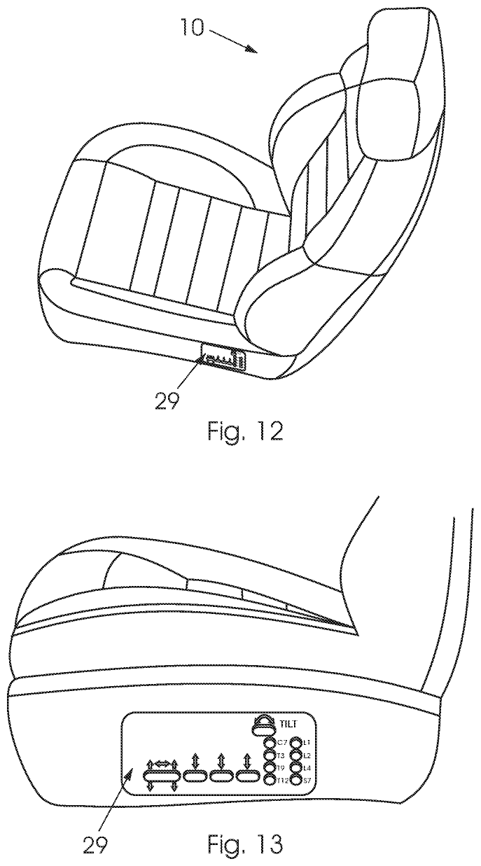

FIGS. 11-13 illustrate another example of a seat arrangement 10 with upholstery (e.g. used for car seats). As shown specifically in FIG. 11, support formations 26.1-26.10 can be secured to respective ends of the support cushions 20. Each support formation 26.1-26.10 may be a bladder/bladder arrangement which is inflatable (e.g. under control of the control module 40 described later on). Alternatively, each support formation 26.1-26.10 may be a type of actuator with a Perspex-like rib to push the backing of the seat arrangement 10 into correct measurements.

In an alternative embodiment shown in FIG. 21, the support members are in the form of bladders 600.1-600.10 which together form a bladder arrangement. In this example, each bladder 600.1-600.10 is connectable to an adjustment arrangement in the form of a control/valve unit 602.1-602.10 which is configured to control the supply of air (or fluid) to the bladder 600.1-600.10 in order to either inflate or deflate the bladder 600.1-600.10, thereby to accommodate a particular sitting profile. In other words, the principle of operation is similar as described above in relation to the other embodiments, except that the support formations 602.1-602.9 are inflated or deflated depending on the particular sitting profile (i.e. in order to provide more or less support for a person's spine at a particular location). The control/valve units 602.1-602.10 are connected to the control module 40, which controls and operates the units 602.1-602.10 in order to adapt the bladders 600.1-600.10 individually to accommodate and support a particular sitting profile (through inflation or deflation). For example the more inflated a bladder is (e.g. bladder 600.3) the more forwards it protrudes/extends/projects.

### Measurements Using the Spinal Measurement Tool

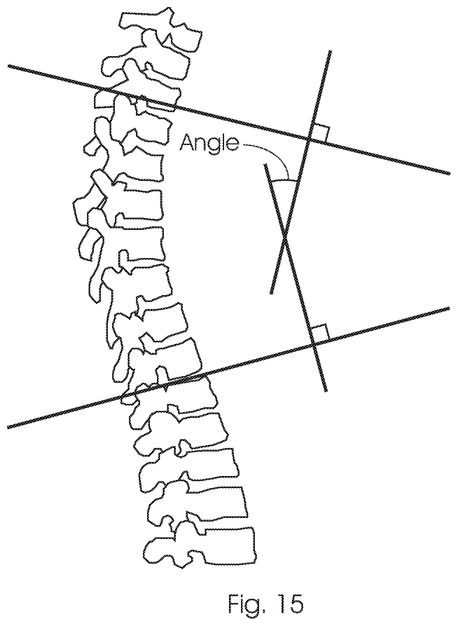

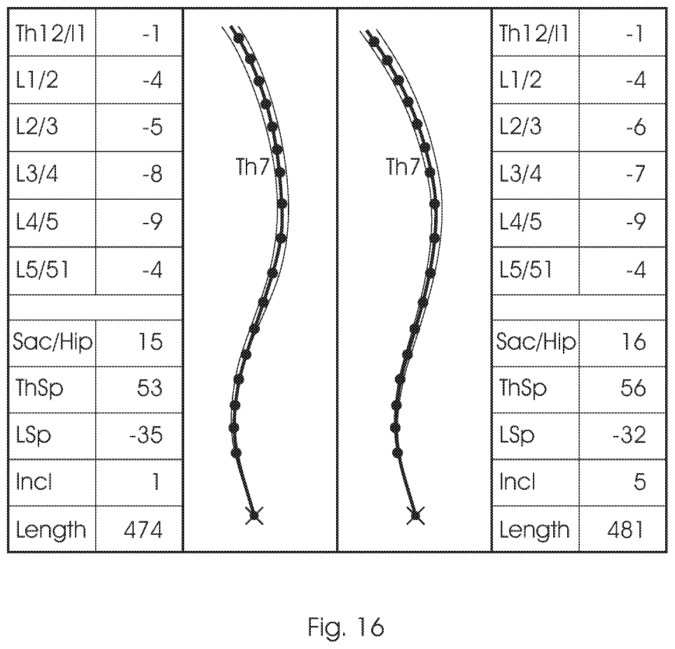

By using the Spinal mouse M360 hand held device as developed by IDIAG AG, as the spinal measurement tool 220, measurements are done through rolling the device 220 along the spine (or other body parts), giving data in various manners, including total angles and individual angles. Reference is in this regard made to the table illustrated in FIG. 16 which sets out the measurements for two different people, taken by the device. In the table:
Th12/L1 refers to the relative change in angle between the 12^{th} Thoracic vertebra (Th12/T12) and 1st Lumbar vertebra (L1) (in degrees);
L1/L2 refers to the relative change in angle between L1 and L2 (in degrees);
L2/L3 refers to the relative change in angle between L2 and L3 (in degrees);
L3/L4 refers to the relative change in angle between L3 and L4 (in degrees);
L4/L5 refers to the relative change in angle between L4 and L5 (in degrees);
L45/S1 refers to the relative change in angle between L5 and S1 (in degrees);
Sac/Hip refers to the relative change in angle between the sacrum and the hips (in degrees);
ThSp refers to the total angle of the thoracic spine (see the angle indicated in FIG. 15) (in degrees);
LSp refers to the total angle of the lumbar spine (see FIG. 16) (in degrees); and
Length refers to the spinal length in mm.

These measurements are then sent to the mobile app installed on the mobile phone 202 of the medical practitioner 206 via wired/wireless communication (e.g. Bluetooth) (see FIG. 18). The mobile app then creates a sitting profile for the user 208, using the measurements. The sitting profile is sent, via wireless communication, to the mobile app installed on the mobile phone 204 of the user 208, so that it can be saved thereon. The sitting profile is also sent to a central server 210 for storing it on a database 212. The sitting profile may also be sent to a cloud based server 214, via a communication network 302, for storing it in the cloud.

In some instances, the measurements can be adapted/transformed slightly (e.g. for medical reasons, for example when the measurements are not within a “safe” “ ” healthy” range), before being finalised. This can be done by the medical professional 206 via his/her mobile app or by the user 208 via his/her mobile app.

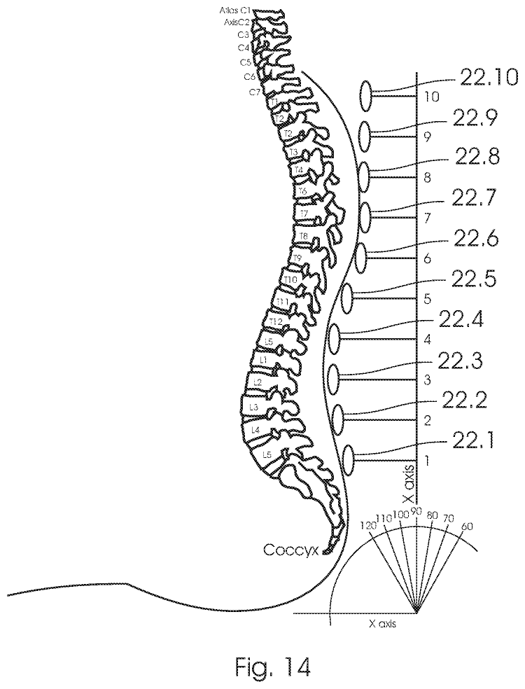

The seat arrangement 10 includes a control module 40 which is operatively connected to each of the actuators 22, in order to control each of them individually/selectively. The control module 40 is configured, when receiving/retrieving a sitting profile for a particular user, to utilise the actuators 22 in order to adjust the rib formations 20 (or other type of support formations) selectively into a position which corresponds with the sitting profile. For example if the relative angle between L1 and L2 is X degrees, then the rib formations 20 which corresponds to L1 and L2 will be adjusted by the control module 40 in order to support a person's back at the same angle (i.e. at X degrees). In this regard, reference is specifically made to FIG. 14 which demonstrates how an actuator/bladder system of the seat arrangement 10 makes changes in space by increasing/decreasing the distance from the Y-axis (formed by the back support structure 17), which results in a change of angle between the rib formations 20.

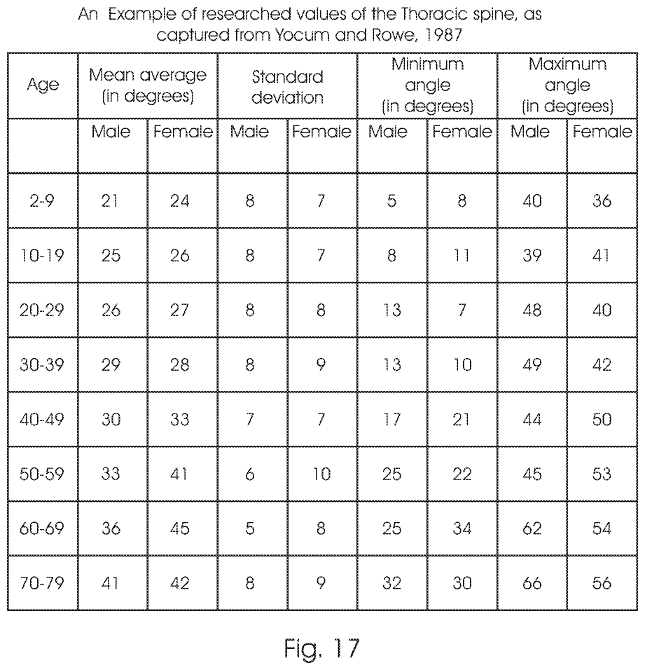

The table set out in FIG. 17 shows an example of research values depicting the average curvatures and ranges of the thoracic spine. Similar research-based values/ranges can also be a used for other curvatures.

In should be appreciated that the seat arrangement 10 can be implemented on any product, machine or device which allows for a seated surface. The seat arrangement 10 can also be implemented in a variety of different ways, depending on the specific application. For example:
In motor vehicles (e.g. trucks, cars, etc.): A user 210 can have the chair arrangement 10 adapted to their unique body measurements for a tailored setup position. This is relatively easy, since it only takes about 5 minutes to take the user's measurements using the spinal measuring tool 220 and generate a sitting profile for the user 208. The sitting profile is then stored on (i) the mobile app installed on the phone 204 of the user 208 and (ii) the databases 212 and 214 in the manner as described above. In addition, the sitting profile can also be stored on an electronic key 240 of the vehicle (e.g. on an internal database of the key 240). This scenario will, for example, occur during the purchase of a new vehicle which incorporates the chair arrangement 10. A wireless communication module 44 of the vehicle, or more specifically of a chair arrangement 10 of the vehicle, can receive/retrieve the sitting profile stored on the key 240 via wireless communication (e.g. Bluetooth) and then automatically adjust the chair arrangement 10 according to the sitting profile.
Wheelchair users: As the body measurements are pivotal for wheelchair users (e.g. paraplegics or quadriplegics), their body anthropometric data is used by the present invention to place them in the most comfortable and correct position. In this instance, rib formations 20 and actuators 22 can be used to make the desired changes to match the body measurements, as well as offer a pulsing function to minimize the risk of developing body sores from prolonged sitting. The pulsing function can typically be implemented by the control module 40.
Pilot chairs or military vehicle chairs: Pilot chairs 10 can be equipped with a barcode reader 42 on the cockpit chair 10 itself or somewhere close thereto. As all pilots 212 are required to have a full medical examination once a year, the assessment of their spines and body, using the spinal measuring tool 220, can be included in this examination. Pilots 212 are often required to wear an identification badge/card 242. The sitting profile can accordingly be incorporated into the badge (e.g. via a QR code or other barcode) or card 242 (e.g. via a QR code or other barcode, or stored on a database of the card 242, e.g. an RFID card). A pilot 212 can then use his badge/card 242 so that it can be scanned by reader 42, in order to allow for a complete and automated setup according to their sitting profile.
Office chairs: Office chairs 10 can make use of manually adjustable backing ribs 20 which can be adjusted to a range which corresponds to the exact measurements of the level of the vertebrae and its natural position whilst sitting offering maximum support at the right level.

When seated in a chair arrangement 10 (e.g. a seat of a motor vehicle which incorporates the invention's technology), the user 208 can use a control panel 29 of the chair arrangement 10, which is operatively connected to the control module 40 of the chair arrangement 10, in order to make manual adjustments to the seat setup. The control panel 29 can include buttons/options to move the seat forwards or rearwards and to adjust each of the support members 12 individually. The control panel 29 may be configured to limit the adjustment so that the relative angles of support provided by the support members 12 remain within “safe“ ” healthy” ranges. These ranges may, for example, be: a cervical curvature of negative 20-40 degrees, a thoracic curvature of positive 20-40 degrees, a lumbar curvature of 40-60 degrees, a hip angle 110-120 degrees, knee flexion angle 20-30 degrees, an elbow flexion of 30 degrees.

Once the user 208 is happy with the seat position, an adjusted sitting profile, which corresponds with the new seat position, is sent back to the mobile app installed on the phone 204. The phone 204 then stores the updated sitting profile and sends it to the central server 210 for storing in the database 212 and in the cloud 214.

The mobile app mentioned above is therefore used to store the user's details (e.g. his sitting profile) and allow for changes to be made if deemed fit. It allows the user 208 control over his recommended settings, following the initial measurement (using the spinal measuring tool 220). This will ensure that in an instance where an injury has occurred, the user can override the recommended setting to alter the support levels, whether it is to increase or decrease the support. This will also allow medical or health practitioners 206 to make changes based on changing data, e.g. aging or post-surgery. The app is configured to allow for easy communication between the mobile phone 204 of the user 208, the mobile phone 202 of the medical practitioner 206, the chair arrangements 10 and the central server 210, in order make changes to the sitting profile for the user.

In a scenario where two users 208 are in a vehicle and both users 208 have the mobile app and a particular sitting profile, the app can connect to a specific chair arrangement 10 of the vehicle (e.g. the driver seat or the passenger seat), so that each user 208 can have a personalised seat.

Details of all measurements taken, as well as the sitting profiles (typically without any personal identification information) are sent to the cloud-based environment 214 for storage purposes. This information can then be accessed and used by researchers 250 (e.g. using a computer 252 or smart device), as well as companies building vehicles and crafts, to determine averages of a population's anthropometric data of its users in a particular area/location (e.g. people in a specific country). As more users get measured, more information will be automatically uploaded onto the cloud 214, via the mobile app, thereby enriching the data with valuable information on averages, ages, curvatures, genders, etc., across the world.

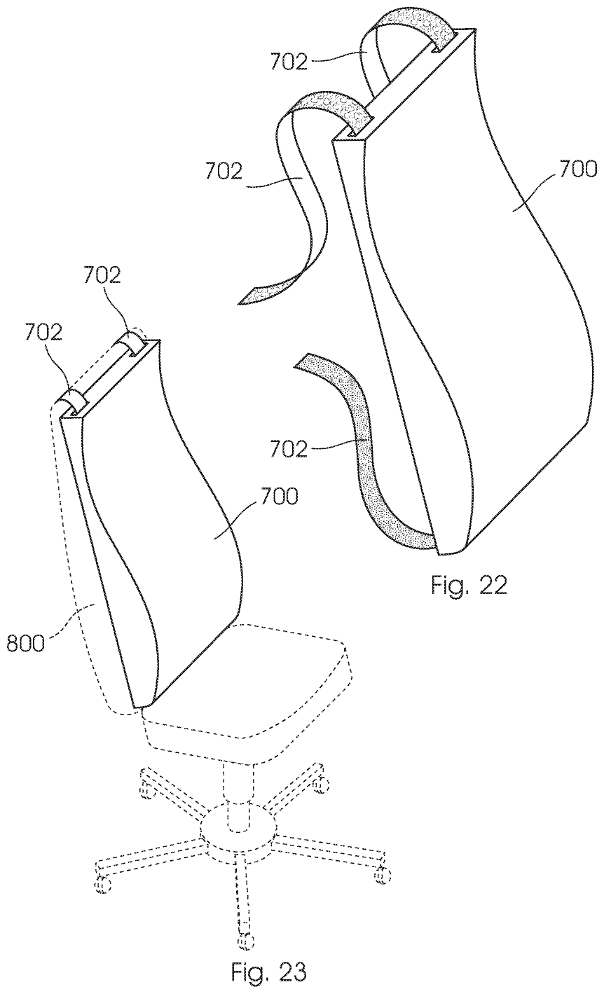

In a slight alternative embodiment the sitting profile can be used to manufacture/design/produce a separate support/support member (or support insert/cut-out) 700 which can support the specific person's spine and back on different chairs 800 (see FIGS. 22 and 23). More specifically the support 700 may be cushioned and shaped to accommodate and support the specific person's spine and back, when seated on a chair 800. The support 700 can therefore be fitted over/on top of an existing chair/seat 800 and can, for example, be secured releasably to a chair 800 by means of straps 702. The support 700 may be a foam-based cut-out.

From the above it will be clear that the present invention provides a tailored sitting surface which takes all body parameters into account. This has not been done to date, since measurements such as individual vertebral angles, sectional spine angles, length of spine, arm lengths and leg lengths have never been utilised in combination during the development of “healthy” sitting ergonomics, especially when considering mass production.

With current adjustable chair arrangements, users can typically modify their seat position into a comfortable position by using a control panel or manual actuators. This creates a problem whereby a user can place themselves into an incorrect position due to the lack of good understanding regarding healthy ergonomics. The present invention negates this problem since it uses researched based values and accurate measurements through the use of a researched spinal measuring tool which provides accurate measurements. The measurements taken by the Spinal Mouse™ have been found to be up to 97% accurate to that of an X-ray of the spine and its angles. This will allow the user to be placed in the most ideal positions for their body types.

Through this unique adjustment, the invention aims to help minimize the prevalence of discomfort, pain and greater health risks during sitting, taking into account the pressure that is placed on the intervertebral discs of the spine during incorrect sitting. The automated seat adjustment requires minimalistic input from the user. This makes using the seat simple and hassle free, and helps to ensure that the user can be placed in a most ideal and healthy sitting position at the push of a button (e.g. unlocking car causes seat to be moved into correct position for user; a pilot swiping his key card on the card reader of the chair results in the chair adjusting into a position which corresponds to the sitting profile of the pilot). The invention allows for a global solution to comfort and good sitting postures. As the data in the cloud grows (whilst maintaining individual anonymity), large sample sizes can be used by companies of a particular region/country. Making global data available on the variations of spinal curvatures, body types and lengths of different populations of people, i.e. Australia vs America vs Europe, future technology, research and sitting products, can be more adapted to these variations amongst populations of people of different origins and places. The present invention therefore provides a growing “cloud-like” data base which can be used by manufacturing companies (purchasing our information) to make easier choices regarding sizing or shaping of products to fit the greater average of the population within their region. Another example may be a surgeon accessing the measurements of his patient, should a surgery have been performed i.e. part fusion of the lumbar spine, the surgeon can make changes to the patient's data allowing for a new generated code which will now accommodate to the patient's new parameters as he uses his sitting structure.

1. An adjustable/personalised seat arrangement, wherein the seat arrangement includes:
a plurality of support members which, in use, supports different portions of a person's back, when the person is seated on the seat arrangement;
at least one adjustment arrangement which is configured to selectively adjust each support member, relative to the other support member(s); and
a control module which is configured to
receive/retrieve information which can be translated to, or corresponds to, a particular seating position for a specific person, wherein the received/retrieved information also relates to, or corresponds to:
a spinal length of the specific person's spine,
one or more spinal curvatures of the spine, and/or
individual vertebral angles of the spine, and
utilise the received/retrieved information and the adjustment arrangement in order to selectively adjust each support member into a position which corresponds with and supports the specific person's back, when the person is seated on the seat arrangement.

2. The seat arrangement of claim 1, wherein the received/retrieved information relates to, or corresponds to: the spinal length of the specific person's spine, individual vertebral angles of the spine, a lumbar curvature of the spine, a cervical curvature of the spine and a thoracic curvature of the spine.

3. The seat arrangement of claim 2, wherein the received/retrieved information includes information which relates to a pelvic hip angle of the specific person, an arm length and/or leg length.

4. The seat arrangement of claim 1, which includes a wireless communication module which is configured to receive the information via wireless communication, which is then utilised by the control module.

5. The seat arrangement of claim 1, which includes a reader/scanner which is configured to retrieve/capture the information from a key, tag or visual code.

6. The seat arrangement of claim 1, wherein at least a portion of the plurality of support members are spaced along a length of the spine of the person, when the person is seated on the seating arrangement, in order to form a back support.

7. The seat arrangement of claim 1, wherein the plurality of support members include:
one or more support members which, in use, supports a lumbar region of a person's back/spine;
one or more support members which, in use, supports a thoracic region of a person's back/spine;
one or more support members which, in use, supports a sacral region of a person's back/spine;
one or more support members which, in use, supports a cervical region of a person's neck/spine; and
one or more support members which, in use, supports a person's buttocks region, thereby providing a seat support.

8. The seat arrangement of claim 1, wherein one or more of the support members include a bladder/bladder arrangement and an adjustment arrangement for each bladder/bladder arrangement, wherein the control module is operatively connected to each adjustment arrangement and is configured to use each adjustment arrangement in order to inflate or deflate its associated bladder/bladder arrangement, based on the received/retrieved information, in order to support the person's back/spine.

9. A system for adjusting a seat for a particular person, wherein the system includes:
a spinal measuring system/arrangement/tool/device or a spinal assessment system/arrangement/tool/device which is configured to measure one or more of the following:
a spinal length of the specific person's spine,
one or more spinal curvatures of the spine, and/or
individual vertebral angles of the spine; and
a seat arrangement as claimed in claim 1,
wherein the control module is configured to utilise measurement information which relates to, or corresponds with, the measurement(s) taken by the spinal measuring system/arrangement/tool/device or the spinal assessment system/arrangement/tool/device, in order to adjust each support member into a position which corresponds with and supports the specific person's back, when the person is seated on the seat arrangement.

10. The system of claim 9, wherein the one or more spinal curvatures of the spine includes a lumbar curvature of the spine, a cervical curvature of the spine and/or a thoracic curvature of the spine.

11-16. (canceled)

17. A method of creating a personalised seat/sitting profile for a particular person, wherein the method includes:
taking measurements of the particular person's spine; and
generating, by using a processor, a seat/sitting profile for the person by utilising the measurements.

18. The method of claim 17, wherein the sitting profile includes details of a specific seating configuration for the particular person.

19. The method of claim 18, wherein the measuring step includes using a spinal measuring tool/device/system to take measurements of the person's spine.

20. The method of claim 19 wherein the measuring step includes guiding the spinal measuring tool/device/system along a spine of the person, in order to take the measurements.

21. The method of claim 17, wherein the measurements relate to:
a spinal length of the specific person's spine,
one or more spinal curvatures of the spine,
individual vertebral angles of the spine,
an arm length of the specific person, and
a leg length of the specific person.

22-23. (canceled)
